(19) United States
(12) Patent Application Publication
(10) Pub. No.: US 2024/0104615 A1
(43) Pub. Date: Mar. 28, 2024

(54) SYSTEM AND METHOD FOR VALUING AND MANAGING CELLULAR COMMUNICATIONS ELECTRONIC DEVICES

(71) Applicant: PrologMobile, Inc., Louisville, CO (US)

(72) Inventors: Seth David Heine, Louisville, CO (US); Jonathan Richard Newman, Saint Augustine, FL (US); Daniel Thomas Ricci, Peyton, CO (US); Zachary Alan Vorwaller, Peyton, CO (US)

(21) Appl. No.: 18/524,429

(22) Filed: Nov. 30, 2023

Related U.S. Application Data
(63) Continuation-in-part of application No. 17/140,262, filed on Jan. 4, 2021, now abandoned.

(51) Int. Cl. G06Q 30/0283; G06F 11/07; G06Q 10/20

(52) U.S. Cl. CPC G06Q 30/0283; G06F 11/0766; G06Q 10/20

(57) ABSTRACT

A computer-implemented system for managing, processing, refurbishing of electronic devices, is disclosed. The computer-implemented system is configured to: (a) receive device information from electronic device receiving and collection points, in which users insert electronic devices; (b) extract unique device identification number based on device information; (c) retrieve device characteristic information, from device information repositories; (d) determine device status information of the electronic devices based on the device characteristic information; (e) identify compatibility of network carriers with the electronic devices; (f) link the electronic devices with potential carriers; (g) diagnose fault factors based on linking of the electronic devices with potential carriers; (h) determine refurbishing price by price determination technique based on fault factors; (i) determine financial value of the electronic devices for reusage in device reusage paths; (j) tract status of repairs, refurbishment interventions, fault recovery processes of electronic devices; and (k) generate reports by device analytics techniques.

### CROSS-REFERENCE TO RELATED APPLICATIONS

The present application is a continuation-in-part of U.S. patent application Ser. No. 17/140,262, filed on Jan. 4, 2021, and titled “System and method for valuation of an electronic device”, each of the above-identified applications is fully incorporated herein by reference. Additionally, incorporation of US patent (U.S. Pat. No. 11,711,755 B1) is present, as a necessary component to this application.

### TECHNICAL FIELD

Embodiments of the present disclosure generally relate to a system for managing the life cycle of a cellular radio connected device at the point of device collection and management points and more particularly to a computer-implemented system and a method for managing identification of one or more cellular communications based electronic devices device, a status of the one or more cellular communications based electronic devices in one or more hardware, electronic, and radio status, device-associated attributes including encumbrances at the device and radio level, and an estimation of asset value in consideration of the one or more cellular communications based electronic devices at present and future states.

### BACKGROUND

The prevalence of consumer electronic devices, including mobile phones, laptop computers, notebooks, and tablets, has become widespread. These electronic devices are extensively utilized globally, with their numbers surpassing the Earth's population. The rapid proliferation of radio-connected consumer electronic devices, notably mobile phones, and wearables, can be attributed to their continuous evolution in terms of advanced features and the growing demand for diverse hardware and software options. This dynamic technological progression leads to a significant proportion of connected devices being replaced annually, as end-users including organizations and consumers seek improvements in features, operational capabilities, or as replacements for damaged or lost electronic devices. In the context of mobile phones, a physical asset class that degrades in price contains electronic components (and often regulations surrounding repair and disposal of these devices), the management and replacements of devices requires information about each electronic device and it's estimated economic value. In consumer oriented situations, many device collection and management points include electronic device retailers and cellular network service providers, which facilitate trade-in or buyback initiatives. In such initiatives, the collection point must receive, identify, evaluate and process each electronic device, the process of which includes an incredibly diverse and highly variable set of attributes, including variability between devices originally intended for use in the collection point's local/regional/national market, and the electronic devices intended for other markets. Additionally, there increasingly is presence of regulatory requirements on second-life electronics in terms of electronic device identification and information in a second-life ecosystem. Such requirements include but aren't limited to consumer oriented information about the electronic device and its' fit for use status, data sanitation certification, and other processing activities, all of which constitute and require the identification and assessment of the electronic device and its estimated value to the electronic device collecting party, if any, as well as repair interventions and subsequent processing the device requires, for the electronic device to be returned to use.

The assessment determination is broadly categorized into three outcome paths: scrap the electronic device for parts and materials, process the electronic device for use in another market, process the electronic device for use in the current market. This assessment at device collection is thus conducted by such device collection and management entities, averting the inappropriate and illegal disposal of electronic devices in improper methods or landfills, recuperating device materials, or for conversion of the electronic device into economic merits, including cash and cash-equivalents/in-store credits, and the like.

Conventional systems for electronic device valuation frequently involve a collection of individual devices, or batches or asset lots of multiple devices, followed by individual diagnosis and physical analysis. However, while diagnostic applications and systems can test the device's physical and electronic attributes, including screens, buttons, and the like, these conventional systems critically lack comprehensive data on the devices' radio capabilities, as well as the radio's IMEI association to a network carrier or other encumbrances of the radio or device itself, or a non-subjective evaluation of their cosmetic condition. Such conventional approaches primarily rely on subjective and superficial evaluations, concentrating on identifying hardware failures including broken components, damages, and cosmetic issues, without using a systematized methodology or standardized set of conditions. Furthermore, these conventional systems can ascertain the existing physical problems of a device with potential resale value, however the conventional systems struggle to ascertain the measures or costs linked to device repair or reuse, whether in the current or another market, subsequently impacting the devices' operational and financial viability. Moreover, these conventional systems necessitate intermediaries and third party data providers for value assessment, many of which offer only partial solutions and lack transparency in the “back to market” flow of devices back into the resale process of electronic devices to the next usage path, whether with consumers or organizations.

Hence, there is a need for an improved computer-implemented system and a method for managing, processing, refurbishing, and reporting of one or more cellular communications based electronic devices, to address at least the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a computer-implemented system for managing, processing, refurbishing, and reporting of one or more cellular communications based electronic devices. The computer-implemented system includes one or more electronic device receiving and collection points and a server communicatively coupled to the one or more electronic device receiving and collection points. The server comprises one or more hardware processors and a memory. The memory is coupled to the one or more hardware processors. The memory includes a plurality of modules in the form of programmable instructions executable by the one or more hardware processors.

The plurality of modules includes a device information receiving module, a device information extracting module, a device characteristic information retrieving module, a device status determining module, a compatibility identifying module, a carrier linking module, a device diagnosing module, a device information displaying module, a device refurbishing price determining module, a device value determining module, a device repair tracking module, and a report generating module.

The device information receiving module is configured to receive device information associated with the one or more cellular communications based electronic devices, from the one or more electronic device receiving and collection points. The device information is determined by the one or more electronic device receiving and collection points, upon receiving the one or more cellular communications based electronic devices from a user, based on at least one of an automated intake inspection and one or more electronic interrogation methods of the one or more cellular communications based electronic devices through at least one of: one or more interface cables, a wireless network, and an installation of one or more applications. The device information extracting module is configured to extract a unique device identification number associated with the one or more cellular communications based electronic devices, based on the received device information.

The device characteristic information retrieving module is configured to retrieve device characteristic information corresponding to at least one of the unique device identification number and a batch identification number, from one or more device information repositories. The device status determining module is configured to determine device status information of the one or more cellular communications based electronic devices based on the retrieved device characteristic information. The device status information comprises at least one of one or more network bands, one or more radio network technologies, and one or more network compatibilities and subscriber identity module encumbrance (SIM-encumbrance) status across one or more potential network options. The compatibility identifying module is configured to identify a compatibility of the one or more network carriers with the one or more cellular communications based electronic devices.

The carrier linking module is configured to link the one or more cellular communications based electronic devices with one or more potential carriers, upon identification of the one or more network compatibilities and the SIM-encumbrance, a device lock encumbrance status, and one or more device encumbrances comprising one or more lost and reports. The device diagnostics module is configured to diagnose one or more fault factors associated with the one or more cellular communications based electronic devices, based on linking of the one or more cellular communications based electronic devices with one or more locales of the one or more potential carriers. The device information displaying module is configured to display device information comprising at least one of the unique device identification number, one or more details and technical specifications, compatibility status, diagnostic events, repair history reference, and the one or more fault factors, of the one or more cellular communications based electronic devices in one or more visualization forms.

The device refurbishing price determining module is configured to determine a refurbishing price, using a price determination technique, based on at least one of the diagnosed one or more fault factors and one or more associated points of intervention identified by the device diagnostics module. The device financial value determining module is configured to determine a weighted financial value of each of the one or more cellular communications based electronic devices for reusage in each of one or more device reusage paths. The device repair tracking module is configured to track status of at least one of each of one or more repairs, refurbishment interventions, and one or more fault recovery processes of each of the one or more cellular communications based electronic devices. The report generating module is configured to generate reports comprising in-depth information associated with each of the one or more cellular communications based electronic devices, using one or more device analytics techniques comprising at least one of a graphical technique, a tabular technique, and data analytics and manipulation techniques. The in-depth information comprises at least one of the unique device identification numbers, the device characteristic information, a status of at least one of hardware, electronic and radio, the one or more fault factors and associated points of intervention for device refurbishment, and one or more functionalities, of the one or more cellular communications based electronic devices.

An aspect of the present disclosure provides a computer-implemented method for managing, processing, refurbishing, and reporting of one or more cellular communications based electronic devices. The computer-implemented method includes receiving device information associated with the one or more cellular communications based electronic devices, from one or more electronic device receiving and collection points. The device information is determined by the one or more electronic device receiving and collection points, upon receiving the one or more electronic cellular communications based devices from a user, based on at least one of an automated intake inspection and one or more electronic interrogation methods of the one or more cellular communications based electronic devices through at least one of: one or more interface cables, a wireless network, and an installation of one or more applications. Further, the computer-implemented method includes extracting a unique device identification number associated with the one or more cellular communications based electronic devices, based on the received device information. Furthermore, the computer-implemented method includes retrieving device characteristic information corresponding to at least one of the unique device identification number and a batch identification number, from one or more device information repositories.

Further, the computer-implemented method includes determining device status information of the one or more cellular communications based electronic devices based on the retrieved device characteristic information. The device status information includes at least one of one or more network bands, one or more radio network technologies, and one or more network compatibilities and subscriber identity module encumbrance (SIM-encumbrance) status across one or more potential network options. Additionally, the computer-implemented method includes identifying a compatibility of the one or more network carriers with the one or more electronic cellular communications based devices. Further, the computer-implemented method includes linking the one or more cellular communications based electronic devices with one or more potential carriers, upon identification of the one or more network compatibilities and the SIM-encumbrance, a device lock encumbrance status, and one or more device encumbrances comprising one or more lost and reports.

Furthermore, the computer-implemented method includes diagnosing one or more fault factors associated with the one or more cellular communications based electronic devices, based on linking of the one or more cellular communications based electronic devices with one or more locales of the one or more potential carriers. Further, the computer-implemented method includes displaying device information comprising at least one of the unique device identification number, one or more details and technical specifications, compatibility status, diagnostic events, repair history reference, and the one or more fault factors, of the one or more cellular communications based electronic devices in one or more visualization forms. Additionally, the computer-implemented method includes determining a refurbishing price, using a price determination technique, based on at least one of the diagnosed one or more fault factors and one or more associated points of intervention identified by a device diagnostics module.

Further, the computer-implemented method includes determining a weighted financial value of each of the one or more cellular communications based electronic devices for reusage in each of one or more device reusage paths. Furthermore, the computer-implemented method includes tracking status of at least one of each of one or more repairs, refurbishment interventions, and one or more fault recovery processes of each of the one or more cellular communications based electronic devices. Additionally, the computer-implemented method includes generating reports comprising in-depth information associated with each of the one or more cellular communications based electronic devices, using one or more device analytics techniques comprising at least one of a graphical technique, a tabular technique, and data analytics and manipulation techniques. The in-depth information includes at least one of the unique device identification number, the device characteristic information, a status of at least one of hardware, electronic and radio, the one or more fault factors associated points of intervention for device refurbishment, and one or more functionalities, of the one or more cellular communications based electronic devices.

Yet another aspect of the present disclosure provides a non-transitory computer-readable storage medium having instructions stored therein. When executed by one or more hardware processors, cause the one or more hardware processors to receive device information associated with one or more cellular communications based electronic devices, from one or more electronic device receiving and collection points. The device information is determined by the one or more electronic device receiving and collection points, upon receiving the one or more cellular communications based electronic devices from a user, based on at least one of an automated intake inspection and one or more electronic interrogation methods of the one or more cellular communications based electronic devices through at least one of: one or more interface cables and an installation of one or more applications. Further, the one or more hardware processors extracts a unique device identification number associated with the one or more cellular communications based electronic devices, based on the received device information. Furthermore, the one or more hardware processors retrieves device characteristic information corresponding to at least one of the unique device identification number and a batch identification number, from one or more device information repositories. Additionally, the one or more hardware processors determines device status information of the one or more cellular communications based electronic devices based on the retrieved device characteristic information. The device status information comprises at least one of one or more network bands, one or more radio network technologies, and one or more network compatibilities and subscriber identity module encumbrance (SIM-encumbrance) status across one or more potential network options. Further, the one or more hardware processors identifies a compatibility of the one or more network carriers with the one or more cellular communications based electronic devices.

Furthermore, the one or more hardware processors links the one or more cellular communications based electronic devices with one or more potential carriers, upon identification of the one or more compatibilities and SIM-encumbrance, a device lock encumbrance status, and one or more device encumbrances comprising one or more lost and reports. Additionally, the one or more hardware processors diagnoses one or more fault factors associated with the one or more cellular communications based electronic devices, based on linking of the one or more cellular communications based electronic devices with one or more locales of the one or more potential carriers. Additionally, the one or more hardware processors displays device information comprising at least one of the unique device identification number, one or more details and technical specifications, compatibility status, diagnostic events, repair history reference, and the one or more fault factors of the one or more cellular communications based electronic devices in one or more visualization forms. Further, the one or more hardware processors determines a refurbishing price, using a price determination technique, based on at least one of the diagnosed one or more fault factors and one or more associated points of intervention identified by a device diagnostics module. Furthermore, the one or more hardware processors determines a weighted financial value of each of the one or more cellular communications based electronic devices for reusage in each of one or more device reusage paths. Additionally, the one or more hardware processors tracks status of at least one of each of one or more repairs, refurbishment interventions, and one or more fault recovery processes of each of the one or more cellular communications based electronic devices. Further, the one or more hardware processors generates reports comprising in-depth information associated with each of the one or more cellular communications based electronic devices, using one or more device analytics techniques comprising at least one of a graphical technique, a tabular technique, and data analytics and manipulation techniques. The in-depth information comprises at least one of the unique device identification numbers, the device characteristic information, a status at least one of hardware, electronic and radio, the one or more fault factors associated points of intervention for device refurbishment, and one or more functionalities, of the one or more cellular communications based electronic devices.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a computer-implemented system for managing refurbishment of one or more cellular communications based electronic devices, in accordance with an embodiment of the present disclosure;

FIG. 2 illustrates an exemplary block diagram representation of a computer implemented server, processors, input/output bus, memory, storage, and modules, such as those shown in FIG. 1, capable of valuation and management of one or more cellular communications based electronic devices, in accordance with an embodiment of the present disclosure;

FIG. 3 illustrates a block diagram representation of the computer-implemented system for valuation of the one or more cellular communications based electronic devices, in accordance with an embodiment of the present disclosure;

FIG. 4 illustrates a flow chart depicting a computer-implemented method of managing refurbishment of the one or more cellular communications based electronic devices, in accordance with the embodiment of the present disclosure; and

FIG. 5 illustrates an exemplary block diagram representation of a hardware platform for implementation of the disclosed computer-implemented system, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or s “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

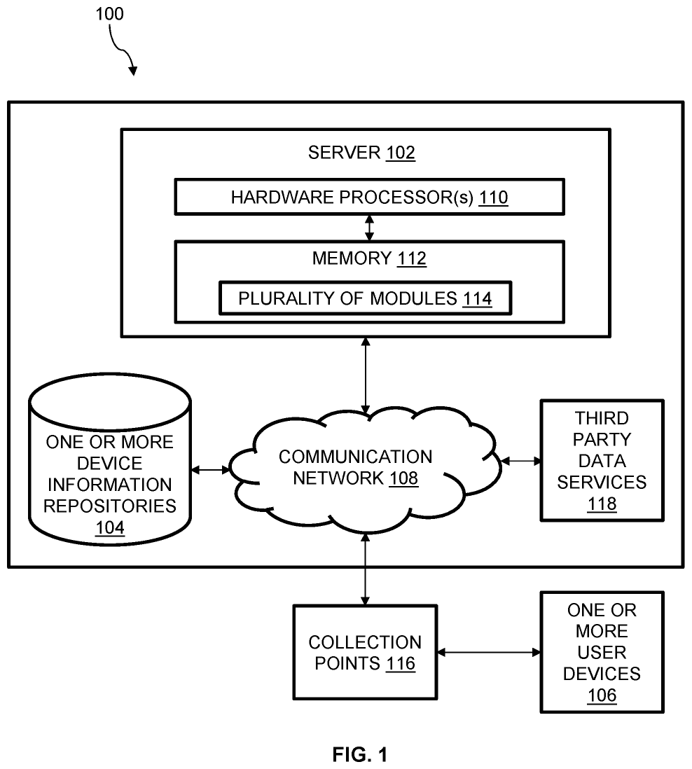

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 illustrates an exemplary block diagram representation of a network architecture implementing a computer-implemented system 100 for managing refurbishment of one or more cellular communications based electronic devices, in accordance with an embodiment of the present disclosure. According to FIG. 1, the network architecture includes a server 102, one or more device information repositories 104, one or more user devices 106, one or more electronic device receiving and collection points 116, and third-party data services 118. In an embodiment, the one or more electronic device receiving and collection points 116 may include organizations with a large number of devices under management including an insurance company, and electronic device retailers and cellular network service providers with at least one of automated and manual interactions, or via at least one of automated and standalone physical machines for collecting one or more cellular communications based electronic devices. The one or more user devices 106 may be associated with one or more users, and communicatively connected via the one or more electronic device receiving and collection points 116 to the server 102 through a communication network 108. Further, the communication network 108 may be a wired network or a wireless network. The server 102 may be at least one of, but not limited to, a central server, a cloud server, a remote server, and the like. Further, the server 102 may be communicatively connected to the one or more device information repositories 104, via the communication network 108. The one or more device information repositories 104 may include at least one of, but is not limited to, device information, device identification number, device characteristic information, device status information, network band information, network carrier information, sim-lock status, in-depth information, hardware status, fault factor information, functionality of components information, original equipment manufacturer (OEM) information, OEM locations, model numbers, model name, technical specification, last active state location, last network connection information, tamper status, inactivity status, payment status, unfulfilled service contract status, subscriber identity module (SIM) status, battery status, display status, cosmetic issues, any other data, and combinations thereof. The one or more device information repositories 104 may be any kind of databases/repositories including at least one of, but are not limited to, relational repositories, dedicated repositories, dynamic repositories, monetized repositories, scalable repositories, cloud repositories, distributed repositories, any other repositories, and combination thereof. The third-party data services 118 may include any data service provider which contributes data about a device using the device's unique identifier or other identifying information, including but not limited to, all data points enumerated in the description of the one or more device information repositories 104, as mentioned above.

Further, the one or more user devices 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a used electronics collection point, an electronics repair facility, an electronics buy-back program operator, an electronics waste processor, or any other organizations owning a plurality of user devices in 106 such as, but not limited to a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The one or more user devices 106 may be used to provide input and/or receive output to/from the server 102, and/or to the one or more device information repositories 104, respectively. The one or more user devices 106 may present to one or more user interfaces to the user to interact with the server 102 and/or to the one or more device information repositories 104 for managing the refurbishment of the one or more cellular communications based electronic devices. The one or more user devices 106 may be at least one of, an electrical device, an electronic device, an electromechanical device, a computing device, and the like. The one or more user devices 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the server 102 may be implemented by way of a single device or a combination of multiple devices that may be operatively connected or networked together. The server 102 may be implemented in hardware or a suitable combination of hardware and software. The server 102 includes one or more hardware processor(s) 110, and a memory 112. The memory 112 may include a plurality of modules 114. The server 102 may be a hardware device including one or more hardware processors 110 executing machine-readable program instructions for managing refurbishment of electronic devices. Execution of the machine-readable program instructions by the one or more hardware processors 110 may enable the proposed server 102 to manage refurbishment of the one or more cellular communications based electronic devices. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory 112 operationally coupled with the server 102 for performing tasks such as data processing, input/output processing, and/or any other functions. Any reference to a task in the present disclosure may refer to an operation being or that may be performed on data.

Though few components and modules are disclosed in FIG. 1, there may be additional components and subsystems which are not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/modules shown in FIG. 1. Although FIG. 1 illustrates the server 102, and the one or more user devices 106 connected to the device information repository 104, one skilled in the art can envision that the server 102, and the one or more user devices 106 can be connected to several user devices located at different locations and several databases via the communication network 108.

Those of ordinary skilled in the art will appreciate that the hardware depicted in FIG. 1 may vary for particular implementations. For example, other peripheral devices including an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the server 102 as is unique to the present disclosure or necessary for an understanding of the present disclosure is depicted and described. The remainder of the construction and operation of the server 102 may conform to any of the various current implementations and practices that were known in the art.

In an exemplary embodiment, the network architecture or the computer-implemented system 100 may include the server 102. The server 102 may be communicatively connected to the one or more electronic device receiving and/or collection points 116 (also referred to as one or more electronic device collection and management points 116). Further, the server 102 may be configured to receive device information associated with the one or more cellular communications based electronic devices, from the one or more electronic device receiving and/or collection points 116. The device information is determined by the one or more electronic device receiving and collection points 116, upon receiving the one or more cellular communications based electronic devices from the user, based on physical and electronic interaction with the one or more cellular communications based electronic devices, including but not limited to connecting the one or more cellular communications based electronic devices by a cable or a wireless network to a computer processor or any other means, such as installing an application, for running diagnostics and erasure, as well as by manual and visual assessment. Further, the server 102 may be configured to extract a unique device identification number and/or batch identification number, associated with the one or more cellular communications based electronic devices, based on the received device information. In one embodiment, the unique device identification number may be at least one of: an international mobile equipment identity number (IMEI) number, a manufacturer's serial number, any any subset of characters included in the unique device identification number which may represent a batch identification number.

Furthermore, the server 102 may be configured to retrieve device characteristic information corresponding to at least one of the unique device identification number, and the batch identification number, from the one or more device information repositories 104. The device characteristic information includes at least one of, but is not limited to, the original equipment manufacturer (OEM) information, the OEM locations, the model numbers, the model name, the technical specification, the last active state location, the last network connection, device-encumbrance status, radio-encumbrance status, and the like. Further, the server 102 may be configured to determine device status information of the one or more cellular communications based electronic devices based on the retrieved device characteristic information. The device status information includes at least one of, but is not limited to, one or more network bands, network technologies and other radio capabilities, associated network carriers and the like, responsible for sim-encumbrance status and/or device-encumbrance status, and the other status attributes.

In an exemplary embodiment, the server 102 may be configured to identify compatibility of the one or more network carriers with the one or more cellular communications based electronic devices upon determination of the device status information. The one or more network bands and the one or more network carriers responsible for the sim-lock status may be determined using at least one of the unique device identification number, and information corresponding to the compatibility with the one or more network carriers. The compatibility of the one or more network carriers is identified by sequencing data using one or more of the system and/or methods introduced in U.S. Pat. No. 11,711,755 B1, regarding compatibility with each of the one or more network carriers. Further, the server 102 may be configured to link the one or more cellular communications based electronic devices with one or more potential carriers, upon identification of the compatibility and sim-encumbrance status. Further, the server 102 may be configured to diagnose one or more fault factors and repair factors associated with the one or more cellular communications based electronic devices, based on linking of the one or more cellular communications based electronic devices with the one or more potential carriers in one or more locales. Furthermore, the server 102 may be configured to display device information associated with at least one of, but is not limited to, the unique device identification number, one or more details and technical specifications, compatibility status, diagnostic events, repair history reference, and the one or more fault factors, of the one or more cellular communications based electronic devices in one or more visualization forms. The fault factors include at least one of, but is not limited to, a tamper status, inactivity status, payment status, unfulfilled service contract status, subscriber identity module (SIM) status, battery status, display status, cosmetic issues, functionality of components, repair history reference, and the like.

Additionally, the server 102 may be configured to determine a refurbishing price, using a price determination technique, based on at least one of the diagnosed one or more fault factors, for repair utilizing OEM or third-party parts and/or processors, corresponding to the market in which the one or more cellular communications based electronic devices is associated with. Furthermore, the server 102 may be configured to determine a weighted financial value of each of the one or more cellular communications based electronic devices for reusage in each of one or more device reusage paths. The one or more device reusage paths includes at least one of, but is not limited to, one or multiple market locales such as a country or a plurality of countries, voluntary and involuntary marketplace regulatory schemes and requirements, repair coverages and associated market norms, carrier activation schemes, and the like. Furthermore, the server 102 may be configured to track the device status in regard to the refurbishment process of each of the one or more cellular communications based electronic devices. Further, the server 102 may be configured to generate and present reports comprising in-depth information associated with each of the one or more cellular communications based electronic devices, using refreshed data from status-dependent information providers enabling the ascertainment of the device status in the flow of devices back to the marketplace and device data repository. The in-depth information includes at least one of, but is not limited to, the unique device identification number, the device characteristic information, a status of at least one of hardware, electronic and radio, the one or more fault factors and associated points of intervention for device refurbishment, and one or more functionalities, of the one or more cellular communications based electronic devices.

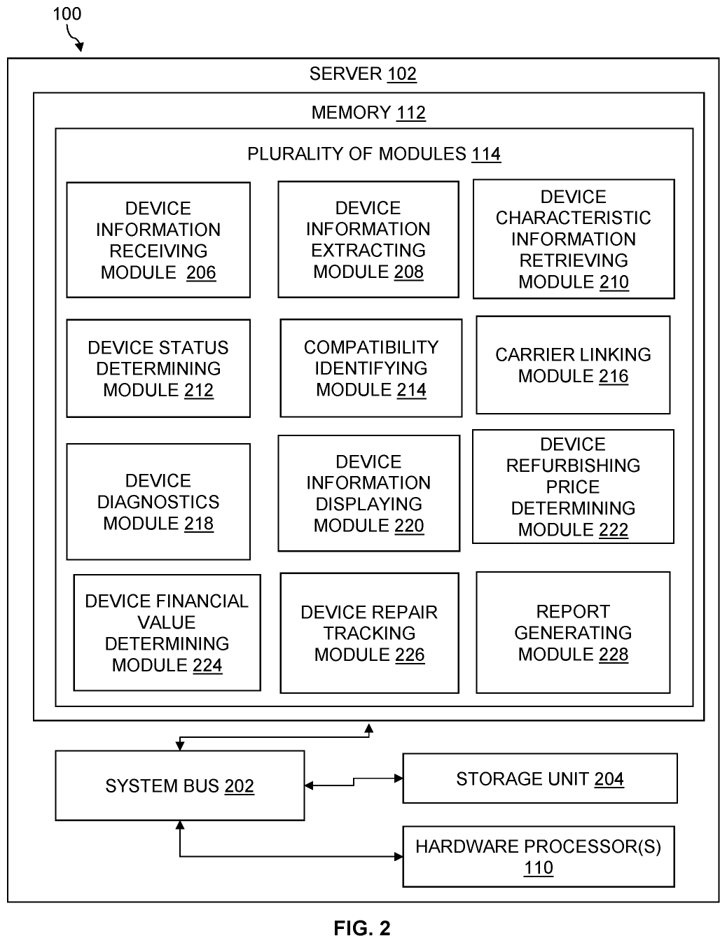

FIG. 2 illustrates an exemplary block diagram representation of the server 102, such as those shown in FIG. 1, capable of valuation and management of the one or more cellular communications based electronic devices, in accordance with an embodiment of the present disclosure. The server 102 may also function as a computer-implemented system/server, and may include the structure of the hardware platform 100. As illustrated, the hardware platform 100 may include additional components not shown, and some of the components described may be removed and/or modified. For example, a computer system with multiple GPUs may be located on external-cloud platforms including Amazon Web Services, internal corporate cloud computing clusters, or organizational computing resources. The server 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises the plurality of modules 114 in form of programmable instructions executable by the one or more hardware processors 110.

Further, the plurality of modules 114 includes, but is not limited to, a device information receiving module 206, a device information extracting module 208, a device characteristic information retrieving module 210, a device status determining module 212, a compatibility identifying module 214, a carrier linking module 216, a device diagnostics module 218, a device information displaying module 220, a device refurbishing price determining module 222, a device financial value determining module 224, a device repair tracking module 226, and a report generating module 228.

The one or more hardware processors 110 may include, for example, the microprocessors, the microcomputers, the microcontrollers, the digital signal processors, the central processing units, the state machines, the logic circuits, and/or any devices that manipulate the data or the signals based on the operational instructions. Among other capabilities, the one or more hardware processors 110 may fetch and execute the computer-readable instructions in the memory 112 operationally coupled with the server 102 for performing tasks such as the data processing, the input/output processing, and/or any other functions. Any reference to the task in the present disclosure may refer to the operation being or that may be performed on the data.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a plurality of cloud storage or any device information repository 104, such as those shown in FIG. 1. The storage unit 204 may store, but is not limited to, the device information, the device identification number, the device characteristic information, the device hardware/electronic/radio status information, information associated with the one or more network bands, network technology information, information associated with the one or more network carriers, the device-encumbrance and sim-encumbrance status, the in-depth information, the hardware status, the fault factor information, the functionality of components information, the original equipment manufacturer (OEM) information, the OEM locations, the model numbers, the model name, the technical specification, the last active state location, the last network connection information, the tamper status, the inactivity status, the payment status, the unfulfilled service contract status, the subscriber identity module (SIM) status, the battery status, the display status, the cosmetic issues, the repair history reference, any other data, and combinations thereof. The storage unit 204 may be any kind of databases/repositories such as, but are not limited to, the relational repositories, the dedicated repositories, the dynamic repositories, the monetized repositories, managed repositories, the scalable repositories, the cloud repositories, the distributed repositories, any other repositories, and combination thereof.

In an exemplary embodiment, the device information receiving module 206 may be configured to receive the device information associated with the one or more cellular communications based electronic devices, from the one or more electronic device receiving and collection points 116. The device information is determined by the one or more electronic device receiving and collection points 116, upon receiving the one or more cellular communications based electronic devices from the user, based on the physical and the electronic interaction with the one or more cellular communications based electronic devices, normally by connecting the one or more cellular communications based electronic devices by the cable or the wireless network to the computer processor or any other means, including installing the application, for running diagnostics and erasure, as well as by visual assessment. Further, the device information extracting module 208 may be configured to extract the unique device identification number associated with the one or more cellular communications based electronic devices, based on the received device information. The unique device identification number may include at least one of: the IMEI, the serial number, and any subset of characters included in the unique device identification number which may represent the batch identification number. The device information extracting module 208 is configured to leverage one or more techniques as a result of potential variations and formatting of the device information available via the device information receiving module 206, in order to identify and extract relevant data attributes that are associated with a device's unique identification. Such techniques may include, but are not limited to, text mapping, tokenization, normalization, and other text analytics methodologies including Levenshtein distances and other comparable, related, and/or associated distance measuring metrics.

In an exemplary embodiment, for extracting the unique device identification number associated with the one or more cellular communications based electronic devices, the device information extracting module 208 is configured to analyze availability of one or more device data. Further, the device information extracting module 208 may be configured to identify the unique device identification number comprising at least one of the international mobile equipment identity (IMEI) number and the serial number. The device information extracting module 208 may be further configured to identify one or more subsets of the unique device identification number that indicates the batch identification number. The device information extracting module 208 may be further configured to acquire the one or more device data facilitating subsequent processing comprising one or more of device fault analysis, device radio compatibility, association of the one or more cellular communications based electronic devices against one or more carrier matches, and financial valuation using weighted multi-variate analysis, based on the unique device identification number.

In an exemplary embodiment, the device characteristic information retrieving module 210 may be configured to retrieve the device characteristic information corresponding to the unique device identification number, from the one or more device information repositories 104 in FIG. 1, or via the one or plurality of storage units 204 in FIG. 2, or other non-transitory media via memory 112 in FIG. 2. Further, the one or more device information repositories 104 may be created by retrieving and integrating one or more data associated with the one or more cellular communications based electronic devices from one or more external sources. The one or more device information repositories 104 stores the device characteristic information of the one or more cellular communications based electronic devices. The device characteristic information includes at least one of, but is not limited to, the original equipment manufacturer (OEM) information, the OEM locations, the model numbers, the model name, the technical specification, the hardware/electronics/radio status, the last active state location, the last network connection, the repair history reference, at least one of radio frequencies, radio network technologies, topology attributes, and the like.

In an exemplary embodiment, the device status determining module 212 may be configured to determine the device status information of the one or more cellular communications based electronic devices based on the retrieved device characteristic information available via the device information receiving module 206. The device status information includes at least one of, but is not limited to, the one or more network bands, radio network technologies, the one or more network carriers responsible for the sim-encumbrance status, and other network compatibility using one or more of the systems and/or methods introduced in U.S. Pat. No. 11,711,755 B1, and the like.

In an exemplary embodiment, the compatibility identifying module 214 may be configured to identify the compatibility of the one or more network carriers with the one or more cellular communications based electronic devices upon determination of the device status information available via the device information receiving module 206. The compatibility identifying module 214 may include, but is not limited to, the systems, methods, and art presented using one or more of the systems and/or methods introduced in U.S. Pat. No. 11,711,755 B1. The one or more network bands, the network technologies, and the one or more carriers responsible for the sim-encumbrance status may be determined using at least one of the unique device identification numbers, and/or batch identification numbers and the information corresponding to the compatibility with the one or more network carriers, sim-lock status, the one or more network carriers responsible for other device lock encumbrances, as well as device disposition, such as being reported as lost/stolen, or otherwise protected by a device management protocol. The compatibility of the one or more carriers is identified is determined by a variety of techniques, and may include, but is not limited to, the systems, methods, and art using introduced in U.S. Pat. No. 11,711,755 B1, and other systems and methods identified by sequencing the data through the filtration of the device capability data and evaluating the compatibility with each of the one or more network carriers. In an exemplary embodiment, the carrier linking module 216 may be configured to link the one or more cellular communications based electronic devices with the one or more potential carriers, upon identification of the compatibility, based on the device-encumbrance and sim-encumbrance and other device lock encumbrances, as well as device disposition, such as being reported as lost/stolen, or otherwise protected by the device management protocol.

In an exemplary embodiment, the device diagnostics module 218 may be configured to diagnose the one or more fault factors associated with the one or more cellular communications based electronic devices, based on linking of the one or more cellular communications based electronic devices with the one or more locales of the one or more potential carriers. The device diagnostics module 218 is configured to enable the identification of a variety of potential fault problems on hardware, electronics, other sub-systems and components, and radio systems, which may require automated or manual intervention in order to rehabilitate the one or more cellular communications based electronic devices to a condition of functionality which satisfies a potential set of market conformity expectations and norms, requirements and definitions, and any other criterion imposed by a marketplace on the transaction of second-life electronic goods such as those in the CTIA's R2 framework.

In an exemplary embodiment, the device information displaying module 220 may be configured to display the device information associated with at least one of, but is not limited to, the unique device identification number, device details and technical specifications, the compatibility status, diagnostic events, and the one or more fault factors, and the repair history reference, of the one or more cellular communications based electronic devices in the one or more visualization forms. The one or more fault factors include at least one of, but are not limited to, the tamper status, the inactivity status, the payment status, the unfulfilled service contract status, the subscriber identity module (SIM) status, the battery status, the display status, the cosmetic issues, the functionality of components, device-encumbrance status, other device management protocols restricting the use of the one or more cellular communications based electronic devices, and the like.

Additionally, the device refurbishing price determining module 222 may be configured to determine the refurbishing price, using the price determination technique, based on at least one of the diagnosed one or more fault factors and one or more associated points of intervention identified by the device diagnostics module 218.

In an exemplary embodiment, the device financial value determining module 224 may be configured to determine the weighted financial value of each of the one or more cellular communications based electronic devices for reusage in each of the one or more device reusage paths. The one or more device reusage paths includes at least one of, but is not limited to, the marketplaces in an economic trade region or country or other locale, the repair coverages, the carrier activation schemes, and the like. Weighting factors may include, but are not limited to device age, repair need of hardware/electronic/radio components and sub-components, identification of market compatibility and associated transactional costs presented by different markets, recency of hardware/electronic/radio component technologies, presence of specific radio frequencies or technologies, presence or lack of device encumbrance restricting device sale or re-use (such as Find My iPhone or other device profile management protocols restricting device access and functionality), presence or lack of the SIM-encumbrance, recent observational data on device prices, completeness of device and associated kit including earphones, charge cables, and the like, inclusion of repair warranty, product warranty, product insurance, quality of materials used such as OEM or aftermarket, suitability for use in the current market, use longevity as measured in terms of devices with out-of-date or superseded communications technologies, certification of the device for the present market locale, and other factors that together comprise a weighting of factors impacting a device's price at the present, and potential future grades, such as through repair interventions to renew device capabilities.

In an exemplary embodiment, the device repair tracking module 226 may be configured to track the status of each of the one or more intervention fault recovery processes of each of the one or more cellular communications based electronic devices. The in-depth information includes, but is not limited to, one or more point on the fault identified, intervention activities and parts replacement prescribed, summary of actions and or parts utilized, confirmation testing of fault recovery and associated data points such as test scores etc., and information on the intervention service provider as well as any outputs, such as the report of a diagnostics program or application.

In an exemplary embodiment, the report generating module 228 may be configured to generate the reports comprising the in-depth information associated with each of the one or more cellular communications based electronic devices, using the one or more device analytics techniques at least one of a graphical technique, a tabular technique, and data analytics and manipulation techniques. The in-depth information includes at least one of, but is not limited to, the unique device identification number, the device characteristic information, the status of at least one of hardware, electronic and radio, the one or more fault factors and associated points of intervention for device refurbishment, and one or more functionalities, of the one or more cellular communications based electronic devices.

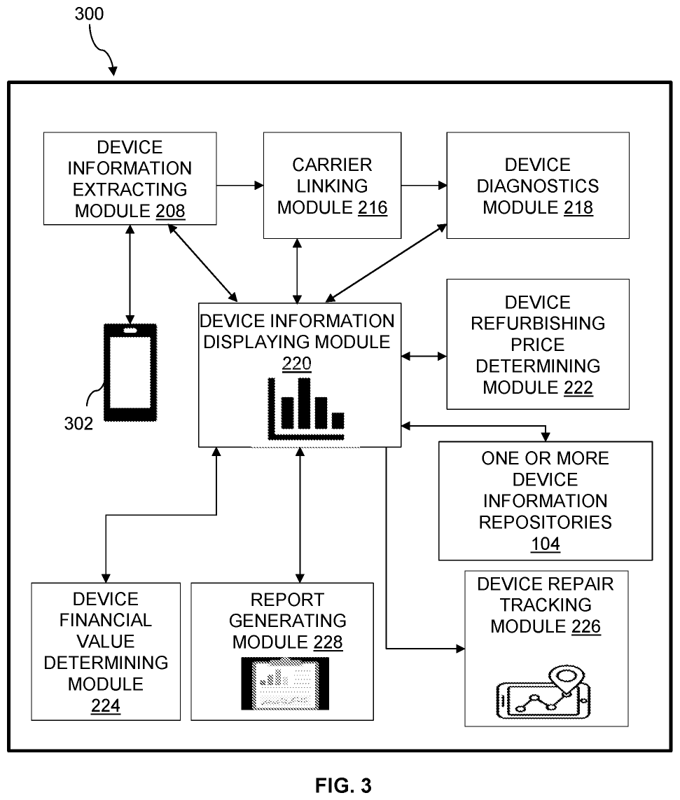

FIG. 3 illustrates a block diagram representation of the computer-implemented system 100 for valuation of the one or more cellular communications based electronic devices, in accordance with an embodiment of the present disclosure. Considering an example, where the server 102, such as in FIG. 1 or in FIG. 2, is utilized by an electronic device seller who wants to sell one or more used electronic devices such as a mobile phone 302 to a customer. In such a scenario, before selling the one or more cellular communications based electronic devices, value analysis of the one or more cellular communications based electronic devices is essential in order to get a fair market value of the mobile phone 302. For valuation of the mobile phone 302, the computer-implemented system 100 as with the system 100, in FIG. 1 or FIG. 2, includes the device information extracting module 208 configured to extract the unique device identification number associated with the one or more cellular communications based electronic devices received in the one or more electronic device receiving and collection points 116. For example, the unique device identification number may include the international mobile equipment identity number (IMEI) number or the serial number. In the example used herein, the one or more electronic device receiving and collection points 116 may commence device interaction by connecting the device by interface cable to a device receiving arrangement or hardware system (system 300), such as a laptop computer, to which the mobile phone is connected for value assessment. The computer-implemented system 300 may be installed as an application on the one or more electronic device receiving and collection points 116. A display interface of the one or more electronic device receiving and collection points 116 displays an analysis result of the one or more cellular communications based electronic devices performed by the computer-implemented system 300. The system 300 is communicatively coupled with the one or more device information repositories 104.

Once the unique device identification number of the one or more cellular communications based electronic devices is derived via the device information extraction module 208, the device information displaying module 220 is further configured to obtain the device characteristic information associated with the one or more cellular communications based electronic devices. For example, the device characteristic information may include at least one of the manufacturing company of the one or more cellular communications based electronic devices, the manufacturing company location of the one or more cellular communications based electronic devices, the model number of the one or more cellular communications based electronic devices, the model name of the one or more cellular communications based electronic devices, attributes of the technical specification of the one or more cellular communications based electronic devices, the specification of the one or more cellular communications based electronic devices, the location of last active state of the one or more cellular communications based electronic devices, the last network connection associated with the one or more cellular communications based electronic devices, the repair history reference or a combination thereof. Let us assume that the manufacturing company of the mobile phone 302 is ‘X’, the model number is ‘ABC-01’, the model's name is ‘Y’. Similarly, the last network connection associated with the mobile phone 302 is ‘Z telecom’. Such device characteristic information associated with the mobile phone 302 helps in detection and presentation of SIM encumbrance data, which may include but is not limited to device-encumbrance and SIM-encumbrance data, enabling more accurate device valuation and more efficient routing of the one or more cellular communications based electronic devices into repair and reuse. Also, the device characteristic information provides an aggregated ability to organize the one or more cellular communications based electronic devices based on IMEI status and hardware fault detection into homogeneous layers of like devices, sorted by cost of resolution or cost of repair, which presents opportunities for repair processing efficiencies, batch handling of inventory, and identification of specific re-usage paths for any specific device held in inventory and processed using the system 300.

Further, the carrier linking module 216 is configured to determine carrier network compatibility of the one or more cellular communications based electronic devices from the plurality of network bands, technologies and sim encumbrance data of each device against the one or more carriers using one or more of the system and/or methods introduced in U.S. Pat. No. 11,711,755 B1. Identification of device compatibility also enables the carrier linking module 216 to associate the one or more cellular communications based electronic devices with the one or more potential carriers and potential economic rewards for the establishment by the end user of a contract with the potential carrier. In the example used herein, the one or more potential carriers may include one or more carriers allowing network connectivity of the one or more cellular communications based electronic devices without sim-locking of the one or more cellular communications based electronic devices. Ability to align the one or more cellular communications based electronic devices with other carrier networks helps in identifying support for the one or more cellular communications based electronic device with the or more carriers into a specific locale of the one or plurality of potential carriers. The locale assists the system in identifying an appropriate re-usage path, which, when combined with the output of the device diagnostic module 218, enables repair activities to align with the needs of the market norms. The device's values and flows shift away from “locking carriers” to carriers with no locks on the one or more cellular communications based electronic devices. Further, the one or more economic rewards may include one or more bring-your-own-device (BYOD) associated or other similar incentives. The BYOD incentives create value for one or more of the device owners, end consumers, the one or more carriers and others, upon successful activation of the one or more cellular communications based electronic devices in a contract to a network.

Further, the device diagnostics module 218 may engage the one or more cellular communications based electronic devices directly or receive the output of a diagnostic interrogation application, in order to evaluate for at least one fault factor associated with the one or more cellular communications based electronic devices based on the manual or automated interrogation of the one or more cellular communications based electronic devices, and an electronic, a physical inspection, or both of the one or more cellular communications based electronic devices. For example, the at least one fault factor may include at least one of the tampered electronic device indicator, the battery issue of the one or more cellular communications based electronic devices, the screen damage of the one or more cellular communications based electronic devices, the one or more cosmetic issues of the one or more cellular communications based electronic devices, a constraint in the functionality of all testable components including buttons, memory or processing chips, cameras, LIDAR, microphones, speakers, proximity sensors, gyroscopes, vibrator etc., or a combination thereof. In addition, the physical cosmetics inspection of the one or more cellular communications based electronic devices is performed manually, or by using one or more device inspection image acquisition devices, or one or more device inspection optical sensors deployed at the one or more electronic device receiving and collection points 116, with assessment against an industry standardized grading and evaluation criteria, such as the CTIA's R2 evaluation specifications. In the example used herein, the one or more device inspection image acquisition devices may include one or more cameras deployed at one or more predetermined points of the one or more electronic device receiving and collection points 116.

Once the diagnostic evaluation is completed and assessment of at least one fault factor is diagnosed and presented such that a bill of materials, that is the parts and materials in order to recover the one or more cellular communications based electronic devices to a future state that meets market requirements, is available. The device refurbishing price determining module 222 may determine the pricing for each repairing and/or refurbishing the one or more cellular communications based electronic devices using the price determination technique that may include, but is not limited to a pricing schedule to value the parts, materials and labor prescribed in the interventions for each type of intervention, as well as market-based price observations. The price determination technique may include, but is not required to do so, compatibility information of the one or more cellular communications based electronic devices, depending on the configuration of the system, as the market locale may require parts compliance and certification, depending on the regulatory or other market frameworks in place in the locale for device re-circulation. The price estimation helps the one or more electronic device receiving and collection points 116 to understand the financial cost associated with interventions to return the one or more cellular communications based electronic devices to salable condition, as well as to obtain recent market-based price observations for the device configuration and SIM encumbrances, which guides both the one or more electronic device receiving and collection points 116 and consumers towards common reference points on the current market value of the one or more cellular communications based electronic devices in its' present condition. With this common point of reference, the seller and transacting parties can decide what should be an appropriate pricing for selling the one or more cellular communications based electronic devices with one or more predetermined features or faults offered. In some embodiments, the pricing also includes repair prices based upon parts/labor/shipping, parts and labor, or parts alone. As an example, here the price for refurbishing the one or more electronic cellular communications based devices may include at least one of, but not be limited to, a buying price applicable for a buyer, the cost of repairs, parts, labor, and shipping of the one or more cellular communications based electronic devices to actuate the repair intervention, and a take to market price applicable for a seller of the one or more cellular communications based electronic devices.

Also, the device financial value determining module 224 may determine a weighted valuation of the one or more cellular communications based electronic devices for reusage via the plurality of device reusage paths based on the price and value created for refurbishing the one or more cellular communications based electronic devices determined, using both the current device condition (with any presented fault factors) as well as potential future states after one or a plurality of repair interventions. In the example used herein, the plurality of device reusage paths may include multiple marketplaces in one or multiple market locales such as a country or a plurality of countries, a repair and/or warranty coverage of the one or more cellular communications based electronic devices, insurance coverage of the one or more cellular communications based electronic devices, a carrier activation incentivizing scheme, or a combination thereof.

Weighting factors may include, but are not limited to device age, repair need of hardware/electronic/radio components and sub-components, identification of market compatibility and associated transactional costs presented by different markets, recency of hardware/electronic/radio component technologies, presence of specific radio frequencies or technologies, presence or lack of device encumbrance restricting device sale or re-use (such as Find My iPhone or other device profile management protocols restricting device access and functionality), presence or lack of SIM-encumbrance, recent observational data on device prices, completeness of device and associated kit including earphones, charge cables, and the like, inclusion of repair warranty, product warranty, product insurance, quality of materials used such as OEM or aftermarket, suitability for use in the current market, use longevity as measured in terms of devices with out-of-date or superseded communications technologies, certification of the one or more cellular communications based electronic devices for the present market locale, and other factors that together comprise a weighting of factors impacting a device's price at the present, and potential future grades, such as through repair interventions to renew device capabilities.

In an exemplary embodiment, the device information displaying module 220 may present to the system user a multiple of attributes and information about a device, such as the unique device identification number, an IMEI compatibility status check, commonly associated device attributes such as the make/model name/model number and the like, the output of the device diagnostic module 218 and associated fault factors identified, the output of the device financial value determining module 224, the repair reference history of the one or more cellular communications based electronic devices, and a presentation of the one or more cellular communications based electronic devices conveyed in the one or more visualization forms. For example, the one or more visualization forms may include, but not be limited to, at least one of the bar graph, the pie chart, the scatter plot, the histogram, the tabular representation, or a combination thereof. In another embodiment, device hardware faults may be visually represented through the likeness of the one or more cellular communications based electronic devices with contrasting colors such as green or red features to communicate the failure (in red) or working (in green) status of the device and its' sub-components and the like, for example.

Furthermore, the device repair tracking subsystem 226 is configured to track a complete repair intervention process of the one or more cellular communications based electronic devices in real-time. As the one or more cellular communications based electronic devices are tracked through these repair interventions, the device hardware status/serialized parts data sets within the system 300 are updated, providing the system 300 the ability to track these data points over multiple lifecycles on the per device basis, enabling life cycle reporting capabilities and a device repair history. The tracking of the repair intervention process helps to identify the status of the one or more cellular communications based devices in it's recovery to become market ready, in assuring device quality and longevity, the ability to associate warranty and other financial products with the device, and supports the multiple productive life cycles.

In addition, the system 300 further includes the report generating module 228 which may generate the plurality of reports to provide in-depth information associated with proprietary analytics of the one or more cellular communications based electronic devices. For example, the device analytics may include at least one of the unique device identification number derived and associated data of the one or more cellular communications based electronic devices, the hardware/electronic/radio status of the one or more cellular communications based electronic devices, the output from the device diagnostic module 218 for at least one fault factor associated with the one or more cellular communications based electronic devices, the functionality of the one or more cellular communications based electronic devices or a combination thereof. In an embodiment, meaningful and accurate reports help in measuring, documenting, and managing an organization's devices in stock, simplification of workflow activities, and understanding how device data contributes to minimizing impact on the environment. Thus, the system 300 enables better decision-making regarding the valuation and re-use path for each specific electronic device analyzed with precision and accuracy, and mitigates the risk factors associated with reuse of the one or more cellular communications based electronic devices. The device repair tracking module 226 may track the repair status of the one or more cellular communications based electronic devices, whether repairs are performed internally by the organization, or via a third-party repair and refurbishment specialist who adds device repair status updates into the system 300.

Various embodiments of the present disclosure relate to a system which brings transparency to the used mobile device market by reducing risk and adding value through a comprehensive hardware and software modularized device data analytics and inventory management platform.

Moreover, the present disclosed system utilizes unique IMEI data associated with the one or more cellular communications based electronic devices for obtaining and enriching device diagnostic data and thus addresses every step of the device management process, from capture via a manual or automated collection point, through repair and refurbishment interventions to final resale by using customized device analytics to identify the one or more cellular communications based electronic devices as an asset, accurately assess the current state of the device's hardware/electronic/radio systems and subsystems, identify the potential future market locale for the one or more cellular communications based electronic devices if the mobile device is not compatible in the current locale, associate future compatibility locales with repair and refurbishment interventions required, and estimate the approximate market-based price range of the asset across various operational and cosmetic states. Hence, the adoption of the system and method presented assists those managing device inventory/assets in the re-use path in obtaining an improved and more accurate fair market value of each cellular communications based electronic device, without the involvement of any mediator in the process.

Furthermore, the present disclosed system offers cost of resolution determination based on categorization of fault codes via diagnostic systems and thus enabling automation of actionable repair quotes and attachment of insurance sale or coverage for the one or more cellular communications based electronic devices, including such interventions in other market locales, depending upon any market compatibility and/or any SIM encumbrances of each cellular communications based electronic device.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

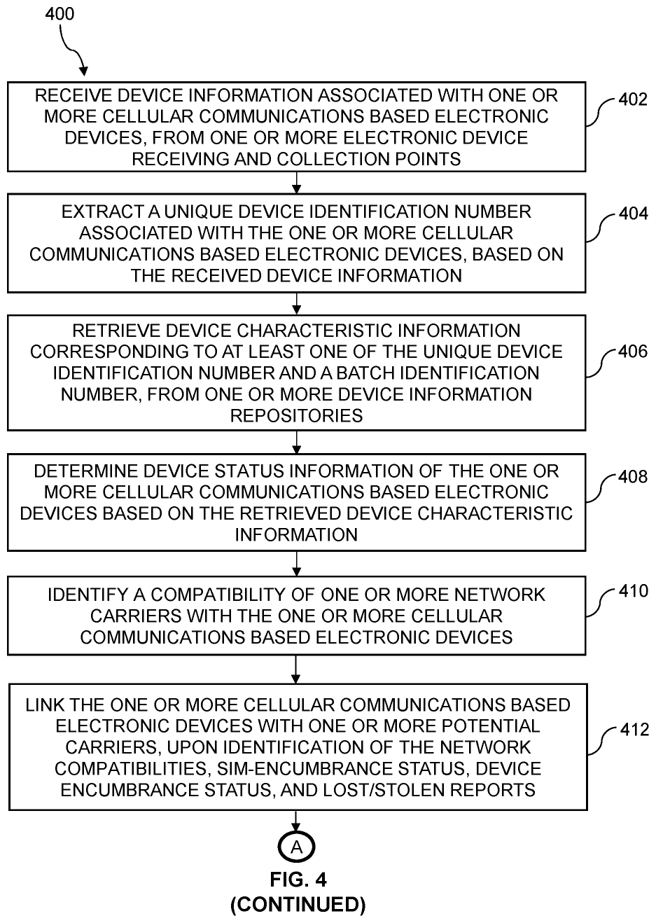

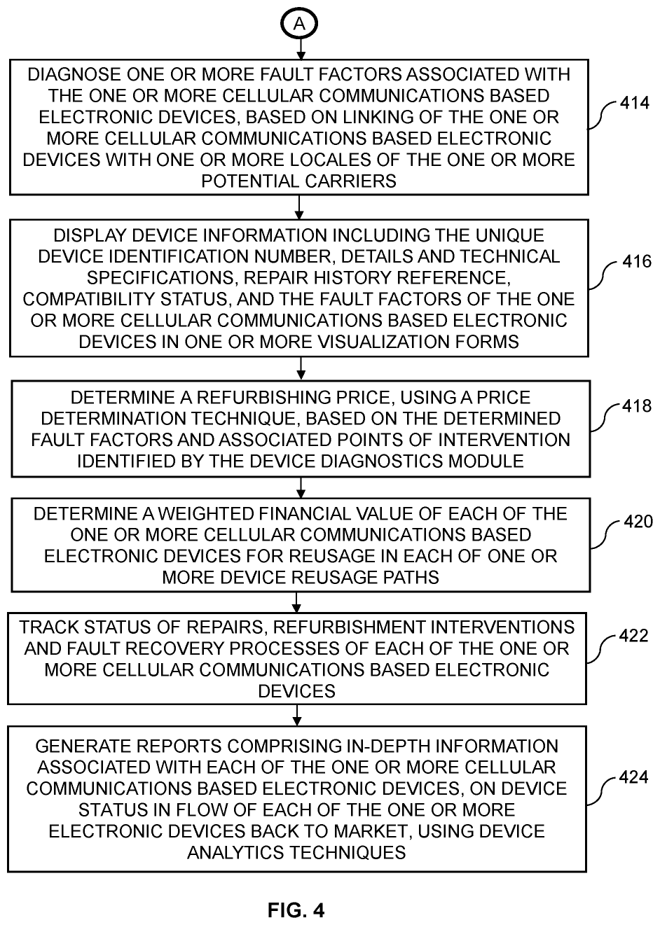

FIG. 4 illustrates a flow chart depicting a computer-implemented method 400 of managing refurbishment of the one or more cellular communications based electronic devices, in accordance with the embodiment of the present disclosure.

At block 402, the device information associated with one or more cellular communications based electronic devices, is received from the one or more electronic device receiving and collection points 116. In an embodiment, the device information is determined by the one or more electronic device receiving and collection points 116, based on manual or automated interrogation of the device, or other manual or automated input of the device information, upon receiving the one or more cellular communications based electronic devices from the user.

At block 404, the unique device identification number associated with one or more cellular communications based electronic devices, is extracted based on the received device information, which may include the IMEI, the serial number, and any subset of characters included in the unique device identification number, which may represent the batch identification number.

At block 406, the device characteristic information corresponding to the unique device identification number, is retrieved from the one or more device information repositories 104.

At block 408, the device status information of the one or more cellular communications based electronic devices is determined based on the retrieved device characteristic information. The device status information comprises at least one of the one or more network bands, the radio network technologies, and the one or more network carriers responsible for the sim-encumbrance status, device disposition including being reported as lost/stolen, or otherwise protected by the device management protocol including Find My iPhone, device management and protection services of an owning organization, and the like.

At block 410, the compatibility of one or more network carriers with one or more cellular communications based electronic devices is determined using one or more of the system and/or methods introduced in U.S. Pat. No. 11,711,755 B1.

At block 412, the one or more cellular communications based electronic devices is linked with the one or more potential carriers, upon identification of the compatibility and the SIM-encumbrance status information.

At block 414, the one or more fault factors associated with the one or more cellular communications based electronic devices, are diagnosed based on linking of the one or more diagnostics report for one or more cellular communications based electronic devices with the one or more regions of network compatibility. The combination of compatibility regions and the one or more fault factors identifies possible constraints in selecting appropriate hardware repair interventions based on market requirements.

At block 416, the device information comprising the unique device identification number, the device characteristic information, the device status information, network band information, the compatibility and associated carrier status, the hardware/electronic/radio status and associated one or more fault factors, of the one or more cellular communications based electronic devices, are displayed in the one or more visualization forms.

At block 418, the refurbishing price, is determined using the price determination technique, based on the diagnosed one or more fault factors, for repair utilizing OEM or third-party parts and/or processors, corresponding to the market the device is associated with.

At block 420, the weighted financial value of each of the one or more cellular communications based electronic devices is determined for reusage in each of the one or more device reusage paths. The one or more device reusage paths includes, but is not limited to, voluntary and involuntary marketplace regulatory schemes and requirements, repair coverage, and associated rules and regulations, carrier activation schemes, and the like. the weighting factors may include, but are not limited to device age, repair need of hardware/electronic/radio components and sub-components, identification of market compatibility and associated transactional costs presented by different markets, recency of hardware/electronic/radio component technologies, presence of specific radio frequencies or technologies, presence or lack of device encumbrance restricting device sale or re-use (such as Find My iPhone or other device profile management protocols restricting device access and functionality), presence or lack of SIM-encumbrance, recent observational data on device prices, completeness of device and associated kit including earphones, charge cables, and the like, inclusion of repair warranty, product warranty, product insurance, quality of materials used such as OEM or aftermarket, suitability for use in the current market, use longevity as measured in terms of devices with out-of-date or superseded communications technologies, certification of the cellular communications based electronic devices for the present market locale, and other factors that together comprise a weighting of factors impacting a device's price at the present, and potential future grades, such as through repair interventions to renew device capabilities.

At block 422, the device status in regard to the repair/refurbishment interventions and processes of each of the one or more cellular communications based electronic devices is tracked.

At block 424, the real-time reports comprising the in-depth information associated with each of the one or more cellular communications based electronic devices, are generated using the regularly refreshed data from status-dependent information providers enabling the ascertainment of the device status in the flow of devices back to the marketplace. The in-depth information comprises the at least one of the unique device identification numbers, the device characteristic information, the hardware/electronic/radio status, repair activities, the fault factors, and the one or more functionalities, of the one or more cellular communications based electronic devices.

The computer-implemented method 400 may be implemented in any suitable hardware, software, firmware, or combination thereof. The order in which the computer-implemented method 400 is described is not intended to be construed as a limitation, and any number of the described method blocks may be combined or otherwise performed in any order to implement the computer-implemented method 400 or an alternate method. Additionally, individual blocks may be deleted from the computer-implemented method 400 without departing from the spirit and scope of the present disclosure described herein. Furthermore, the computer-implemented method 400 may be implemented in any suitable hardware, software, firmware, or a combination thereof, that exists in the related art or that is later developed. The computer-implemented method 400 describes, without limitation, the implementation of the server 102. A person of skill in the art will understand that computer-implemented method 400 may be modified appropriately for implementation in various manners without departing from the scope and spirit of the disclosure.

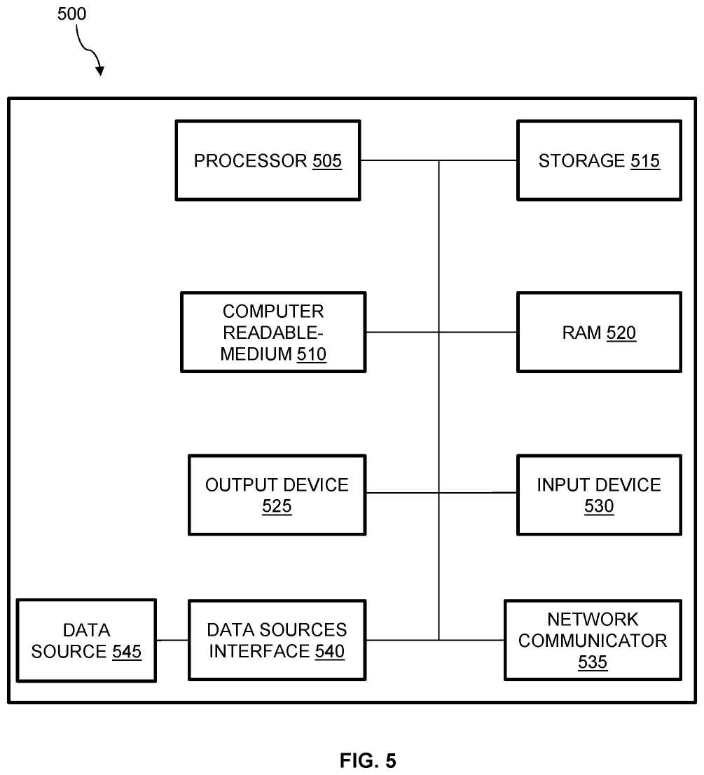

FIG. 5 illustrates an exemplary block diagram representation of a hardware platform 500 for implementation of the disclosed server 102, according to an example embodiment of the present disclosure. For the sake of brevity, the construction, and operational features of the server 102 which are explained in detail above are not explained in detail herein. Particularly, computing machines such as but not limited to internal/external server clusters, quantum computers, servers, workstations, desktops, laptops, virtualized compute environments, smartphones, tablets, and wearables may be used to execute the server 102 or may include the structure of the hardware platform 500. As illustrated, the hardware platform 500 may include additional components not shown, and some of the components described may be removed and/or modified. For example, a computer system with multiple GPUs may be located on external-cloud platforms including Amazon Web Services, internal corporate cloud computing clusters, or organizational computing resources.

The hardware platform 500 may be a computer system such as the server 102 that may be used with the embodiments described herein. The computer system may represent a computational platform that includes components that may be in a server or another computer system. The computer system may be executed by the processor 505 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 505 that executes software instructions or code stored on a non-transitory computer-readable storage medium 510 to perform methods of the present disclosure. The software code includes, for example, instructions to gather data and analyze the data. For example, the plurality of modules 114 includes the device information receiving module 206, the device information extracting module 208, the device characteristic information retrieving module 210, the device status determining module 212, the compatibility identifying module 214, the carrier linking module 216, the device diagnostics module 218, the device information displaying module 220, the device refurbishing price determining module 222, the device financial value determining module 224, the device repair tracking module 226, and the report generating module 228.

The instructions on the computer-readable storage medium 510 are read and stored the instructions in storage 515 or random-access memory (RAM). The storage 515 may provide a space for keeping static data where at least some instructions could be stored for later execution. The stored instructions may be further compiled to generate other representations of the instructions and dynamically stored in the RAM such as RAM 520. The processor 505 may read instructions from the RAM 520 and perform actions as instructed.

The computer system may further include the output device 525 to provide at least some of the results of the execution as output including, but not limited to, visual information to users, such as external agents. The output device 525 may include a display on computing devices and virtual reality glasses. For example, the display may be a mobile phone screen ora laptop screen. GUIs and/or text may be presented as an output on the display screen. The computer system may further include an input device 530 to provide a user or another device with mechanisms for entering data and/or otherwise interacting with the computer system. The input device 530 may include, for example, a keyboard, a keypad, a mouse, or a touchscreen. Each of these output devices 525 and input device 530 may be joined by one or more additional peripherals. For example, the output device 525 may be used to display the results such as bot responses by the executable chatbot.

A network communicator 535 may be provided to connect the computer system to a network and in turn to other devices connected to the network including other clients, servers, data stores, and interfaces, for example. A network communicator 535 may include, for example, a network adapter such as a LAN adapter or a wireless adapter. The computer system may include a data sources interface 540 to access the data source 545. The data source 545 may be an information resource. As an example, a database of exceptions and rules may be provided as the data source 545. Moreover, knowledge repositories and curated data may be other examples of the data source 545.

Embodiments of the present disclosure provide the computer-implemented system 100 and the computer-implemented method 400 for valuation and management of the one or more cellular communication based electronic devices, and more particularly to a system and a method for managing the identification of the one or more cellular communication based electronic devices, the status of the one or more cellular communication based electronic devices in physical, electronic, and radio status and associated attributes, and an estimation of the market valuation of the one or more cellular communication based electronic devices at present and future states for markets in the device re-use path.

The present disclosure performs a comprehensive assessment of the one or more cellular communications based electronic devices, considering at least one of: characteristics, the cellular network compatibility, and the one or more fault factors, and repair activities, and functionalities, of the one or more cellular communication based electronic devices. This holistic approach ensures a more accurate understanding of each device's condition and identification of the most appropriate market locale for the one or more cellular communication based electronic devices to be re-deployed into. Additionally, the system streamlines the re-use paths of a device by identifying device network compatibility linking devices with a plurality of carriers, saving valuable time and resources. This composite data-informed view of the one or more cellular communication based electronic devices extends to the pricing estimation for refurbishment, as the system utilizes fault factors to determine repair options including prices, providing stakeholders with a clear rationale for pricing decisions.

Further, the computer-implemented system 100 further optimizes the evaluation of the one or more cellular communication based electronic devices for reusing the one or more cellular communication based electronic devices by determining their value across one or more reuse paths. This approach maximizes returns and minimizes wastage by aligning the one or more cellular communications based electronic devices with their most suitable reuse scenarios. Real-time tracking of the refurbishment process ensures operational efficiency and timely interventions when necessary. The reporting capabilities of the computer-implemented system 100 are enhanced, generating reports with detailed insights into each device's status in the flow of devices back to the marketplace. This wealth of information empowers decision-makers with valuable data for informed choices regarding refurbishment, pricing, and reuse strategies.

By relying on objective criteria such as network compatibility and device and radio encumbrances, as the destination market may present regulatory conditions to be satisfied for second-life electronics sale, appropriate repair channels and parts can be appropriately determined. By applying consistent methodologies of determining hardware and cosmetic fault factors, the system 100 reduces subjectivity in valuation-impacting criteria such as device identification and evaluation, device hardware and radio encumbrance status, and device grade, contributing to consistency and reliability in assessing the transactional value of a device in its current state. Further, by being informed about market compatibility considerations, the environmental impact of subsequent buy-sell-transport transactions can be reduced. Additionally, by enhancing and improving the transparency and consistency of correctly identified and re-used second-life devices, device owners perception of the viability of cellular communications devices in the reusage paths is improved, further encouraging correct device management practices, in particular at times of device removal from use for upgrades or periodic replacement

The present invention is further configured to facilitate an informed decision regarding the: accuracy and consistency of asset identification; identification of asset attributes to inform of device features and its current state of hardware/electronic/radio subcomponents; identification of where the one or more cellular communications based electronic devices can be resold; establishing the end-market constrained bill of materials for repair or refurbishment, and estimation of a price for the current state and condition of the device as well as the costs to improve the one or more cellular communications based electronic devices through repair and refurbishment interventions, thus enabling the one or more electronic device receiving and collection points 116 to determine the estimated weighted value of any specific device held in inventory.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A computer-implemented system for managing, processing, refurbishing, and reporting of one or more cellular communications based electronic devices, the computer-implemented system comprising:
one or more electronic device receiving and collection points; and
a server communicatively coupled to the one or more electronic device receiving and collection points, the server comprising:
one or more hardware processors; and
a memory coupled to the one or more hardware processors, wherein the memory comprises a plurality of modules in form of programmable instructions executable by the one or more hardware processors, and wherein the plurality of modules comprises:
a device information receiving module configured to receive device information associated with the one or more cellular communications based electronic devices, from the one or more electronic device receiving and collection points, wherein the device information is determined by the one or more electronic device receiving and collection points, upon receiving the one or more cellular communications based electronic devices from a user, based on at least one of an automated intake inspection and one or more electronic interrogation methods of the one or more cellular communications based electronic devices through at least one of: one or more interface cables and an installation of one or more applications;
a device information extracting module configured to extract a unique device identification number associated with the one or more cellular communications based electronic devices, based on the received device information;
a device characteristic information retrieving module configured to retrieve device characteristic information corresponding to at least one of the unique device identification number and a batch identification number, from one or more device information repositories;
a device status determining module configured to determine device status information of the one or more cellular communications based electronic devices based on the retrieved device characteristic information, wherein the device status information comprises at least one of one or more network bands, one or more radio network technologies, and one or more network compatibilities and subscriber identity module encumbrance (SIM-encumbrance) status across one or more potential network options;
a compatibility identifying module configured to identify a compatibility of the one or more network carriers with the one or more cellular communications based electronic devices;
a carrier linking module configured to link the one or more cellular communications based electronic devices with one or more potential carriers, upon identification of the one or more network compatibilities and the SIM-encumbrance, a device lock encumbrance status, and one or more device encumbrances comprising one or more lost and reports;
a device diagnostics module configured to diagnose one or more fault factors associated with the one or more cellular communications based electronic devices, based on linking of the one or more cellular communications based electronic devices with one or more locales of the one or more potential carriers;
a device information displaying module configured to display device information comprising at least one of the unique device identification number, one or more details and technical specifications, compatibility status, diagnostic events, repair history reference, and the one or more fault factors, of the one or more cellular communications based electronic devices in one or more visualization forms;
a device refurbishing price determining module configured to determine a refurbishing price, using a price determination technique, based on at least one of the diagnosed one or more fault factors and one or more associated points of intervention identified by the device diagnostics module;
a device financial value determining module configured to determine a weighted financial value of each of the one or more cellular communications based electronic devices for reusage in each of one or more device reusage paths;
a device repair tracking module configured to track status of at least one of each of one or more repairs, refurbishment interventions, and one or more fault recovery processes of each of the one or more cellular communications based electronic devices; and
a report generating module configured to generate reports comprising in-depth information associated with each of the one or more cellular communications based electronic devices, using one or more device analytics techniques comprising at least one of a graphical technique, a tabular technique, and data analytics and manipulation techniques, wherein the in-depth information comprises at least one of the unique device identification number, the device characteristic information, a status of at least one of hardware, electronic and radio, the one or more fault factors and associated points of intervention for device refurbishment, and one or more functionalities, of the one or more cellular communications based electronic devices.

2. The computer-implemented system of claim 1, wherein, for extracting the unique device identification number associated with the one or more cellular communications based electronic devices, the device information extracting module is further configured to:
analyze availability of one or more device data;
identify the unique device identification number comprising at least one of an international mobile equipment identity (IMEI) number and a serial number;
identify one or more subsets of the unique device identification number that indicates the batch identification number; and
acquire the one or more device data facilitating subsequent processing comprising one or more of device fault analysis, device radio compatibility, association of the one or more cellular communications based electronic devices against one or more carrier matches, and financial valuation using weighted multi-variate analysis, based on the unique device identification number.

3. The computer-implemented system of claim 1, wherein the device characteristic information comprises at least one of the unique device identification number, the batch identification number, original equipment manufacturer (OEM) information, OEM locations, model numbers, model name, technical specification, last active state location, last network connection, the status of at least one of the hardware, the electronic and the radio status, repair history reference, one or more available radio frequencies, and the one or more radio network technologies.

4. The computer-implemented system of claim 1, wherein the one or more network bands, the one or more radio network technologies, and one or more device attributes are analyzed to identify one or more network operators to determine the SIM-encumbrance status using at least one of the unique device identification number, and information corresponding to at least one of the hardware, electronics, radio capabilities, of the one or more cellular communications based electronic devices.

5. The computer-implemented system of claim 1, wherein the compatibility of the one or more network carriers is identified by utilizing band capability data comprising one or more radio bands supported by the one or more cellular communications based electronic devices.

6. The computer-implemented system of claim 1, wherein the one or more fault factors comprise one or more hardware associated faults comprising at least one of a tampered electronic device indicator, a battery issue of the one or more cellular communications based electronic devices, a screen damage of the one or more cellular communications based electronic devices, one or more cosmetic issues of the one or more cellular communications based electronic devices, a constraint in functionality of one or more testable hardware components including buttons, memory and processing chips, cameras, light detection and ranging (LIDAR), microphones, speakers, sensors comprising at least one of proximity sensors, gyroscopes, and vibrators, and radio associated faults comprising at least one of device lock and radio lock status, inactivity status indicating the lost and stolen encumbrances, existing contractual status with a network, payment status, unfulfilled service contract status, and subscriber identity module (SIM) status.

7. The computer-implemented system of claim 1, wherein the one or more device reusage paths comprises one or more marketplaces in one or more locales comprising at least one of one or more countries, a repair warranty coverage of the one or more cellular communications based electronic devices, an insurance coverage of the one or more cellular communications based electronic devices, and a carrier activation incentivizing scheme.

8. The computer-implemented system of claim 1, wherein the one or more fault factors of the one or more cellular communications based electronic devices identified requires repair intervention to restore device functionality, and wherein the device refurbishing price determining module is configured to identify and associate one or more prices for the one or more fault factor device interventions that comprise a locale at the local, regional, national, and multiple national markets in which repair part specifications are affected by at least one of voluntary and regulatory factors, and in which a present physical status of the one or more cellular communications based electronic devices, through interventions, is restored to one or more improved device future states.

9. The computer-implemented system of claim 1, wherein the device repair tracking module is configured to monitor against each cellular communications based electronic device, associated progression and status of repair interventions as the associated progression and status of repair interventions are performed, tracked, and tested to determine whether each cellular communications based electronic device is fit for market requirements based on updates of the repair history reference of the one or more cellular communications based electronic devices.

10. The computer-implemented system of claim 1, wherein the one or more cellular communications based electronic devices are configured to be associated with one or more market price observations corresponding to current and future states of at least one of the hardware, the electronics, the radio capabilities, of the one or more cellular communications based electronic devices, using a weighted multi-variate algorithm to assist in a weighted valuation of the one or more cellular communications based electronic devices under management.

11. A computer-implemented method for managing, processing, refurbishing, and reporting of one or more cellular communications based electronic devices, the computer-implemented method comprising:
receiving, by one or more hardware processors, device information associated with the one or more cellular communications based electronic devices, from one or more electronic device receiving and collection points, wherein the device information is determined by the one or more electronic device receiving and collection points, upon receiving the one or more cellular communications based electronic devices from a user, based on at least one of an automated intake inspection and one or more electronic interrogation methods of the one or more cellular communications based electronic devices through at least one of: one or more interface cables and an installation of one or more applications;
extracting, by the one or more hardware processor, a unique device identification number associated with the one or more cellular communications based electronic devices, based on the received device information;
retrieving, by the one or more hardware processor, device characteristic information corresponding to at least one of the unique device identification number and a batch identification number, from one or more device information repositories;
determining, by the one or more hardware processor, device status information of the one or more cellular communications based electronic devices based on the retrieved device characteristic information, wherein the device status information comprises at least one of one or more network bands, one or more radio network technologies, and one or more network compatibilities and subscriber identity module encumbrance (SIM-encumbrance) status across one or more potential network options;
identifying, by the one or more hardware processor, a compatibility of the one or more network carriers with the one or more cellular communications based electronic devices;
linking, by the one or more hardware processor, the one or more cellular communications based electronic devices with one or more potential carriers, upon identification of the one or more network compatibilities and the SIM-encumbrance, a device lock encumbrance status, and one or more device encumbrances comprising one or more lost and reports;
diagnosing, by the one or more hardware processor, one or more fault factors associated with the one or more cellular communications based electronic devices, based on linking of the one or more cellular communications based electronic devices with one or more locales of the one or more potential carriers;
displaying, by the one or more hardware processor, device information comprising at least one of the unique device identification number, one or more details and technical specifications, compatibility status, diagnostic events, repair history reference, and the one or more fault factors, of the one or more cellular communications based electronic devices in one or more visualization forms;
determining, by the one or more hardware processor, a refurbishing price, using a price determination technique, based on at least one of the diagnosed one or more fault factors and one or more associated points of intervention identified by a device diagnostics module;
determining, by the one or more hardware processor, a weighted financial value of each of the one or more cellular communications based electronic devices for reusage in each of one or more device reusage paths;
tracking, by the one or more hardware processor, status of at least one of each of one or more repairs, refurbishment interventions, and one or more fault recovery processes of each of the one or more cellular communications based electronic devices; and
generating, by the one or more hardware processor, reports comprising in-depth information associated with each of the one or more cellular communications based electronic devices, using one or more device analytics techniques comprising at least one of a graphical technique, a tabular technique, and data analytics and manipulation techniques, wherein the in-depth information comprises at least one of the unique device identification number, the device characteristic information, a status of at least one of hardware, electronic and radio, the one or more fault factors associated points of intervention for device refurbishment, and one or more functionalities, of the one or more cellular communications based electronic devices.

12. The computer-implemented method of claim 11, wherein extracting the unique device identification number associated with the one or more cellular communications based electronic devices, comprises:
analyzing, by the one or more hardware processors, availability of one or more device data;
identifying, by the one or more hardware processors, the unique device identification number comprising at least one of an international mobile equipment identity (IMEI) number and a serial number;
identifying, by the one or more hardware processors, one or more subsets of the unique device identification number that indicates the batch identification number; and
acquiring, by the one or more hardware processors, the one or more device data facilitating subsequent processing comprising one or more of device fault analysis, device radio compatibility, association of the one or more cellular communications based electronic devices against one or more carrier matches, and financial valuation using weighted multi-variate analysis, based on the unique device identification number.

13. The computer-implemented method of claim 11, wherein the device characteristic information comprises at least one of the unique device identification number, the batch identification number, original equipment manufacturer (OEM) information, OEM locations, model numbers, model name, technical specification, last active state location, last network connection, the status of at least one of the hardware, the electronic and the radio status, repair history reference, one or more available radio frequencies, and the one or more radio network technologies.

14. The computer-implemented method of claim 11, wherein the one or more network bands, the one or more radio network technologies, and the one or more device attributes are analyzed to identify one or more network operators to determine the SIM-encumbrance status using at least one of the unique device identification number, and information corresponding to at least one of the hardware, electronics, radio capabilities, of the one or more cellular communications based electronic devices.

15. The computer-implemented method of claim 11, wherein the compatibility of the one or more network carriers is identified by utilizing band capability data comprising one or more radio bands supported by the one or more cellular communications based electronic devices.

16. The computer-implemented method of claim 11, wherein the one or more fault factors comprise one or more hardware associated faults comprising at least one of a tampered electronic device indicator, a battery issue of the one or more cellular communications based electronic devices, a screen damage of the one or more cellular communications based electronic devices, one or more cosmetic issues of the one or more cellular communications based electronic devices, a constraint in functionality of one or more testable hardware components including buttons, memory and processing chips, cameras, light detection and ranging (LIDAR), microphones, speakers, sensors comprising at least one of proximity sensors, gyroscopes, and vibrators, and radio associated faults comprising at least one of device lock and radio lock status, inactivity status indicating the lost and stolen encumbrances, payment status, unfulfilled service contract status, and subscriber identity module (SIM) status.

17. The computer-implemented method of claim 11, wherein the one or more device reusage paths comprises one or more marketplaces in one or more locales comprising at least one of one or more countries, a repair warranty coverage of the one or more cellular communications based electronic devices, an insurance coverage of the one or more cellular communications based electronic devices, and a carrier activation incentivizing scheme.

18. The computer-implemented method of claim 11, further comprising identifying and associating, by the one or more hardware processors, one or more prices for the one or more fault factor device interventions that comprise a locale at the local, regional, national, and multiple national markets in which repair part specifications are affected by at least one of voluntary and regulatory factors, and in which a present physical status of the one or more cellular communications based electronic devices, through interventions, is restored to one or more improved device future states,
wherein the one or more fault factors of the one or more cellular communications based electronic devices identified requires repair intervention to restore device functionality.

19. The computer-implemented method of claim 11, further comprising monitoring, by the one or more hardware processors, against each cellular communications based electronic device, associated progression and status of repair interventions as the associated progression and status of repair interventions are performed, tracked, and tested to determine whether each cellular communications based electronic device is fit for market requirements based on updates of the repair history reference of the one or more cellular communications based electronic devices.

20. A non-transitory computer-readable storage medium having instructions stored therein that, when executed by one or more hardware processors, cause the one or more hardware processors to execute operations of:
receiving device information associated with one or more cellular communications based electronic devices, from one or more electronic device receiving and collection points, wherein the device information is determined by the one or more electronic device receiving and collection points, upon receiving the one or more cellular communications based electronic devices from a user, based on at least one of an automated intake inspection and one or more electronic interrogation methods of the one or more cellular communications based electronic devices through at least one of: one or more interface cables and an installation of one or more applications;
extracting a unique device identification number associated with the one or more cellular communications based electronic devices, based on the received device information;
retrieving device characteristic information corresponding to at least one of the unique device identification number and a batch identification number, from one or more device information repositories;
determining device status information of the one or more cellular communications based electronic devices based on the retrieved device characteristic information, wherein the device status information comprises at least one of one or more network bands, one or more radio network technologies, and one or more network compatibilities and subscriber identity module encumbrance (SIM-encumbrance) status across one or more potential network options;
identifying a compatibility of the one or more network carriers with the one or more cellular communications based electronic devices;
linking the one or more cellular communications based electronic devices with one or more potential carriers, upon identification of the one or more network compatibilities and SIM-encumbrance, a device lock encumbrance status, and one or more device encumbrances comprising one or more lost and reports;
diagnosing one or more fault factors associated with the one or more cellular communications based electronic devices, based on linking of the one or more cellular communications based electronic devices with one or more locales of the one or more potential carriers;
displaying device information comprising at least one of the unique device identification number, one or more details and technical specifications, compatibility status, diagnostic events, repair history reference, and the one or more fault factors, of one or more cellular communications based electronic devices one or more visualization forms;
determining a refurbishing price, using a price determination technique, based on at least one of the diagnosed one or more fault factors and one or more associated points of intervention identified by a device diagnostics module;
determining a weighted financial value of each of the one or more cellular communications based electronic devices for reusage in each of one or more device reusage paths;
tracking status of at least one of each of one or more repairs, refurbishment interventions, and one or more fault recovery processes of each of the one or more cellular communications based electronic devices; and
generating reports comprising in-depth information associated with each of the one or more cellular communications based electronic devices, using one or more device analytics techniques comprising at least one of a graphical technique, a tabular technique, and data analytics and manipulation techniques, wherein the in-depth information comprises at least one of the unique device identification number, the device characteristic information, a status of at least one of hardware, electronic and radio, the one or more fault factors associated points of intervention for device refurbishment, and one or more functionalities, of the one or more cellular communications based electronic devices.

21. The non-transitory computer-readable storage medium of claim 20, wherein extracting the unique device identification number associated with the one or more cellular communications based electronic devices, comprises:
analyzing availability of one or more device data;
identifying the unique device identification number comprising at least one of an international mobile equipment identity (IMEI) number and a serial number;
identifying one or more subsets of the unique device identification number that indicates the batch identification number; and
acquiring the one or more device data facilitating subsequent processing comprising one or more of device fault analysis, device radio compatibility, association of the one or more cellular communications based electronic devices against one or more carrier matches, and financial valuation using weighted multi-variate analysis, based on the unique device identification number.

22. The non-transitory computer-readable storage medium of claim 20, wherein the device characteristic information comprises at least one of the unique device identification number, the batch identification number, original equipment manufacturer (OEM) information, OEM locations, model numbers, model name, technical specification, last active state location, last network connection, the status of at least one of the hardware, the electronic and the radio status, repair history reference, one or more available radio frequencies, and the one or more radio network technologies.

23. The non-transitory computer-readable storage medium of claim 20, wherein the one or more network bands, the one or more radio network technologies, and the one or more device attributes are analyzed to identify one or more network operators to determine the SIM-encumbrance status using at least one of the unique device identification number, and information corresponding to at least one of the hardware, electronics, radio capabilities, of the one or more cellular communications based electronic devices.

24. The non-transitory computer-readable storage medium of claim 20, wherein the compatibility of the one or more network carriers is identified by utilizing band capability data comprising one or more radio bands supported by the one or more cellular communications based electronic devices.

25. The non-transitory computer-readable storage medium of claim 20, wherein the one or more fault factors comprise one or more hardware associated faults comprising at least one of a tampered electronic device indicator, a battery issue of the one or more cellular communications based electronic devices, a screen damage of the one or more cellular communications based electronic devices, one or more cosmetic issues of the one or more cellular communications based electronic devices, a constraint in functionality of one or more testable hardware components including buttons, memory and processing chips, cameras, light detection and ranging (LIDAR), microphones, speakers, sensors comprising at least one of proximity sensors, gyroscopes, and vibrators, and radio associated faults comprising at least one of device lock and radio lock status, inactivity status indicating the lost and stolen encumbrances, payment status, unfulfilled service contract status, and subscriber identity module (SIM) status.
